(19) United States
(12) Patent Application Publication
(10) Pub. No.: US 2025/0165513 A1
(43) Pub. Date: May 22, 2025

(54) ENABLING MULTI-LANGUAGE COLD START SEARCH USING A LARGE LANGUAGE MODEL

(71) Applicant: Maplebear Inc., San Francisco, CA (US)

(72) Inventors: Vinesh Reddy Gudla, South San Francisco, CA (US); Tejaswi Tenneti, San Carlos, CA (US); Shubhanshu Mishra, Woodridge, IL (US)

(21) Appl. No.: 18/948,027

(22) Filed: Nov. 14, 2024

Related U.S. Application Data
(60) Provisional application No. 63/599,769, filed on Nov. 16, 2023.
(60) Provisional application No. 63/604,115, filed on Nov. 29, 2023.

(51) Int. Cl. G06F 16/33; G06F 16/2452

(52) U.S. Cl. CPC G06F 16/3344; G06F 16/24522

(57) ABSTRACT

An online system uses a machine-learned language model (e.g., an LLM) to improve multilingual search capabilities. The system generates a prompt for the LLM that includes a set of search queries in a first language along with their context, as well as a request for translating these queries into a second language. This prompt is sent to a model serving system, which executes it through the LLM and returns translated queries in the second language. Additionally, the concierge system accesses a first set of features derived from the search results in the first language, and updates these features based on the newly translated search queries to create a second set of features. These translated queries and the second set of features are then used to train a search model optimized for queries in the second language.

### CROSS REFERENCE TO RELATED APPLICATIONS

This application claims priority to U.S. Provisional Patent Application Ser. No. 63/599,769, filed on Nov. 16, 2023 and U.S. Provisional Patent Application Ser. No. 63/604,115, filed on Nov. 29, 2023, all of which are incorporated herein by reference in their entirety.

### BACKGROUND

Online systems typically manage large amounts of data. Users interact with these systems through a user interface or any other type of interface designed to help them search for information, products, or services. The process usually begins with a user entering a query or search term into a search bar, which activates a search model to locate relevant results. When a search query is received, it is parsed and converted into a format that can be processed by a database management system (DBMS). Traditionally, this may include using Structured Query Language (SQL) for relational databases or another query language appropriate for NoSQL databases, depending on the architecture of the database. If indexes are available for the queried fields, the DBMS leverages these indexes to efficiently locate relevant records without having to scan the entire database. Once the search model returns the search results, the results are passed back to the frontend of the system.

The system then displays results, which users can further refine by filtering or sorting based on attributes like price, brand, or customer ratings. Some online systems enhance the experience by offering personalized suggestions or recommendations based on the user's prior interactions or popular items. Users can also navigate by browsing categorized menus, clicking links, or selecting featured content displayed on the homepage or other prominent areas. As they explore, users may interact with various forms of content, such as product listings, articles, videos, or social media links, depending on the system's design and purpose. Users can also refine their search by modifying the query, applying additional filters, or using navigation tools to visit different sections of the online system.

### SUMMARY

In some cases, an existing online platform is in a first language, and a new online platform in a second language is to be launched. Typically, this new platform requires a period of time to gather user queries and develop an improved search model for enhanced user experience.

Embodiments described herein address aspects of the above-described problem by using a large language model (LLM) to translate queries of an existing online platform from a first language to a second language and creating new features based on the translated queries, such that a search model may be trained based on the translated queries and new features, and the new model may be deployed on the second online platform in the second language, enabling cold start search.

In some embodiments, an online system generates a prompt for input to a machine-learned language model (e.g., an LLM). The prompt includes (1) a set of one or more search queries (also referred to as “a first set of one or more search queries”) in a first language, (2) context of the set of the one or more search queries, and (3) a request for translating the first set of one or more search queries in the first language to a second set of one or more search queries in a second language.

The online system provides the prompt to a model serving system for execution by the machine-learned language model, and receives, from the model serving system, a response generated by executing the machine-learned language model on the prompt. The response includes a second set of one or more search queries in the second language.

The online system also accesses a first set of features based on user interaction with results of the first set of one or more search queries in the first language, and updates the first set of features based on the second set of one or more search queries in the second language to generate a second set of features. For example, a feature may be a click through rate (CTR) associated with a search term and product ID, which represents a rate at which users click on a product linked to that product ID when they input the corresponding search term. The online system can then train a search model based on the second set of one or more search queries in the second language and the second set of features.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for a method of training a search model in a second language using a large language model (LLM) based on queries and features used to train a search model in a first language, in accordance with one or more embodiments.

FIG. 4A illustrates an example process of generating synthetic data for training various models, in accordance with one or more embodiments.

FIG. 4B illustrates an example process for continuously improving various models in an online platform, in accordance with one or more embodiments.

FIG. 5 is a flowchart for a method of query difficulty estimation process in accordance with one or more embodiments.

### DETAILED DESCRIPTION

Online systems often contain a large amount of data. A user may enter a query or a search term, and the online system may implement a search model to sort through a large amount of data to find specific results based on a given query. The search model takes an input (usually a string of text, which may be the search query) and returns an output of the most relevant results sorted by certain criteria, such as relevance, popularity, click-through rate, or some other metrics or features. In the context of e-commerce platforms, a search model could utilize various machine learning techniques to improve the accuracy and relevance of the search results. For example, it might incorporate features like click-through rates (CTR), user behavior, historical data, and more to predict which results a user is most likely to find useful.

In one or more embodiments, such a search model may be trained based on search logs containing search queries and features. As such, sufficient historical search queries, user interactions, and contextual information (such as user profiles and retailer details) need to be accumulated before effective training can be performed.

The online system may also launch a new online platform in a language different from existing platforms. Upon launching the new online platform, historical data is typically absent, which can result in a suboptimal initial search experience for users. As the platform gathers more data over time, search models can be trained and continually refined to enhance the accuracy of search results. Nevertheless, there exists a period of time between the platform's launch and the availability of enough data to train an effective search model which may result in a significant amount of resources to collect and obtain the data for the target language.

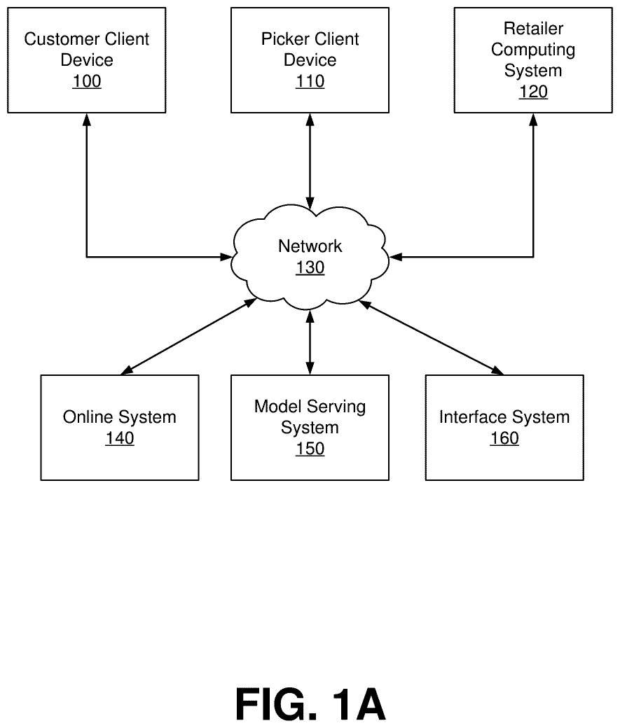

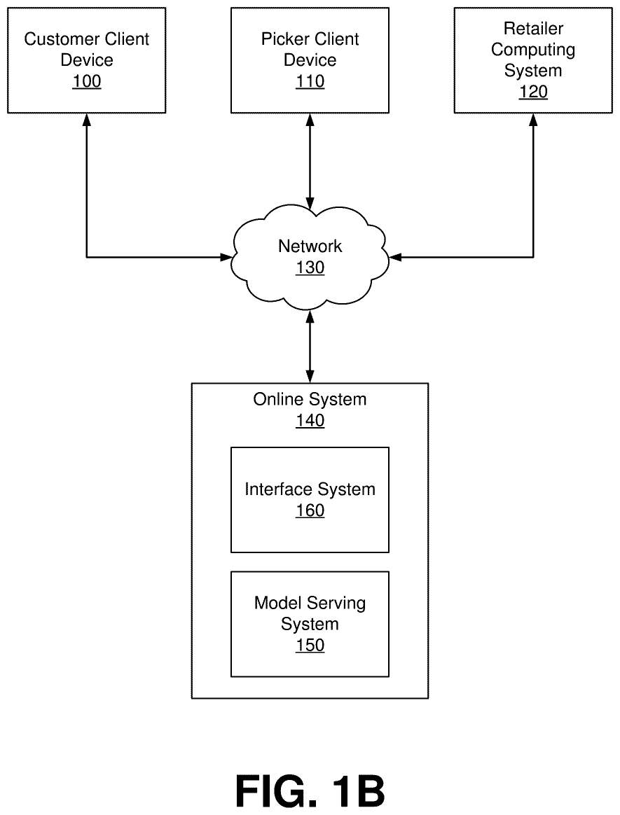

Embodiments described herein address aspects of the above-described problem using data collected from a first platform in a first language to generate synthetic data in a second language, and the synthetic data can then be used to train a search model in the second language. Additional details about these embodiments are described below with respect to FIGS. 1A, 1B, 2-3, 4A, and 4B.

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. In some embodiments, the online system 140 may be an online concierge system. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1A or 1B, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

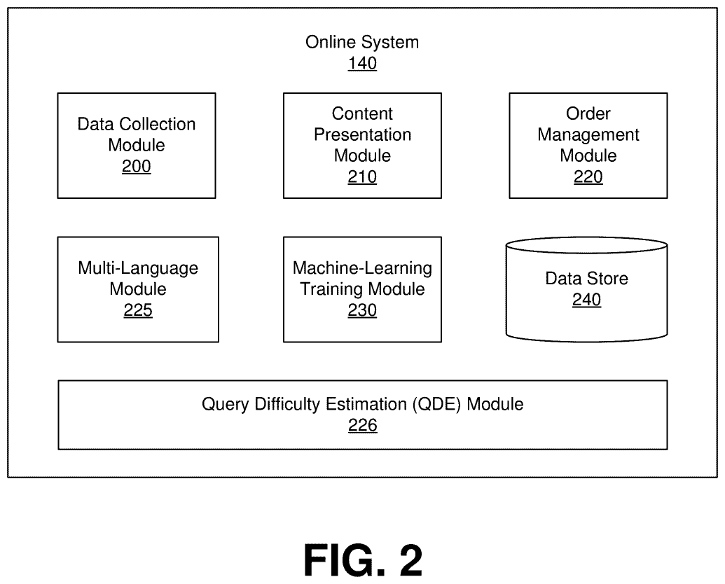

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In one or more embodiments, the online system 140 has a service in a first language, and a search model has been trained based on search queries and features in the first language. The online system 140 is to launch a new service in a second language. For instance, in Canada, some regions are predominantly English-speaking, while others are mainly French-speaking. A first service in English may have been active in the English-speaking regions or in the U.S., and a second service in French is about to be launched. Traditionally, the second service would require a period of time to gather user queries and develop an improved search model for enhanced user experience.

The online system 140 described herein solves this problem by using a large language model (LLM) to translate queries in a first language (which were obtained from the first service) to a second language and creating new features based on the translated queries, such that a search model may be trained based on the translated queries and new features before the second service in the second language is launched. This allows the second service to have a starting point for certain queries based on the data collected from corresponding queries in the first language, greatly improving the accuracy and performance of the second service.

In some embodiments, the online system 140 generates a prompt for input to an LLM. The prompt includes (1) a set of queries in the first language, (2) context of the set of queries, and (3) a request for translating the set of queries in the first language into a set of queries in the second language. For example, the prompt may include context information such as retailer and/or user information. In some embodiments, the context may be captured in search logs along with the queries. The retailer context can capture differences in brands versus categories. For example, the query of “ABC” may be a fruit in a grocery retailer context, it may also be a brand of electronics devices in a consumer electronics retailer context. In including the user information, the prompt may include location information (e.g., where user is located in a particular geographical region) or personalization information (e.g., user has searched previously for dietary attribute for gluten-free options). In some embodiments, the context may also include metadata about top converting products, such as name, category, dietary attributes of the top converting products, etc. for a given query.

The online system 140 provides the prompt to a model serving system 150 for execution by the LLM. The LLM receives the prompt, and generates a response based on the prompt. The online system 140 in turn receives, from the model serving system 150, the response generated by the LLM. The response includes a set of one or more search queries in the second language. Specifically, while one brute force manner is to do a literal translation of the queries in the first language to the second language, often times, different terms refer to different things in different languages and it is difficult to capture the actual meaning of the query via literal translation. Therefore, by using a machine-learned LLM and a prompt including valuable contextual information for the query, the query can be effectively translated into the second language and data for the query can be used to warm-start search models for the new service of the online system 140 in a new language.

Further, the online system 140 accesses a set of features (also referred to as “a first set of features”) generated based on user information with results of the set of search queries in the first language. For example, in accessing the first set of features, the online system 140 may access click through rates (CTRs). Each CTR is associated with a search term and product ID, and the CTR represents a rate at which users click on a product linked to that product ID when they input the corresponding search term. For example, a CTR feature may be a CTR 0.1 associated with a search term “apple” and a product ID “1.” This CTR feature indicates that when a user searches “apple”, the system presents a product linked to product ID “1,” the user has 10% likelihood to click the product link.

The online system 140 updates the first set of features based on the set of search queries in the second language. For example, for the above example CTR feature, the search term “apple” in English may be translated into “pomme” in French. As such, the CTR feature may be updated as a CTR 0.1 associated with a search term “pomme” and a product ID “1.”

The translated search queries and the second set of features can then be used to train a search model, which may include (but are not limited to) category classifiers, search embeddings, etc. In addition, in some embodiments, attributes that are more relevant to a specific language or region may be transferred automatically.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a multi-language module 225, a query difficulty estimation (QDE) module 226, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

### Enabling Multi-Language Cold Start Search Using a Large Language Model

In some embodiments, a “search model” is trained based on search queries in a first language and corresponding features. The features may be generated based on how users engage with the search results corresponding to the search queries. For example, the features may include click through rate (CTRs). Each CTR is associated with a search term and product ID, and the CTR represents a rate at which users click on a product linked to that product ID when they input the corresponding search term. For example, a CTR feature may be a CTR 0.1, it is associated with a search term “apple” and a product ID “1.” This CTR feature indicates that when a user searches “apple”, the system presents a product linked to product ID “1,” the user has 10% likelihood to click the product link.

The search queries, the features, and the search model may be stored in the data store 240. The multi-language module 225 is configured to train a new search model (also referred to as a “second search model”) in a second language.

In some embodiments, multi-language module 225 accesses a set of one or more search queries in the first language, and generates a prompt for input to a machine-learned language model (e.g., an LLM). The prompt includes (1) a set of queries in the first language, (2) context of the set of queries, and (3) a request for translating the set of queries in the first language into a set of queries in the second language. The context may include retailer and/or user information (e.g., location information or personalization information). The context may be captured in search logs along with the query. The retailer context can capture differences in brands versus categories. For example, the query of “ABC” may be a fruit in a grocery retailer context, but an electronics device in a consumer electronics retailer context. As another example, user information can include dietary attributes associated with the user, e.g., gluten-free dietary restrictions. In some embodiments, the context may also include metadata about top converting products, such as name, category, dietary attributes of the top converting products, etc.

In some embodiments, multiple translations may be generated for a same query. For example, the request may include a request to generate different variations of translated queries that take into account and/or append the user's dietary attributes. For example, for the query “oats” in English language for a user who has gluten-free dietary restrictions, the translated variations may include a translated version of “gluten-free oats” among other translated queries. The multi-language module 225 may reuse the best-performing translations to further optimize the prompt and cause the LLM to generate better translations.

Below is an example prompt:

You are an AI assistant that helps translate search queries for a grocery e-commerce platform. Given a user search query in English along with the language to translate into and some additional metadata, you need to generate a few translation candidates that will then be used for improving the search on the platform. Here are some guidelines to help you generate the correct response:
When provided with the retailer type generate translations appropriate to that retailer type
Generate up to 10 different translations if applicable for a given search query
When applicable, generate variations of a search query that a user typically includes like dietary attributes, categories, etc
user: {query: ABC, retailer_type: grocery, language: spanish}
user: {query: ABC, retailer_type: electronics, language: spanish}

For example, assuming “ABC” corresponds to “orange,” which can refer to both a type of fruit and a brand of electronic devices. A sample response that the LLM might generate for the previous prompt could be:
user: {query: orange, retailer_type: grocery, language: spanish}
assistant:
   naranja
   naranjas
   naranja verde
   naranja fresca
   naranja Valencia
   naranja sanguina
   naranja orgánica
user: {query: orange, retailer_type: electronics, language: spanish} assistant:
   teléfono
   Celular
   phone
   Teléfono móvil
   computadora

In some embodiments, the set of queries in the first language are preprocessed to correct spelling errors. In some embodiments, the set of queries in the first language may be reformulated into standard formats. In some embodiments, the set of queries or the request in the first language may be normalized. In some embodiments, the set of queries in the first language or the request may include a single query. Alternatively, the set of queries in the first language may include a batch of queries that share the same context.

In some embodiments, the prompt may include text. Alternatively, or in addition, the prompt may also include image, sound, video, or other modalities of data.

The multi-language module 225 accesses a set of features (also referred to as “a first set of features”) generated based on user interactions with search results corresponding to the set of search queries in the first language, and updates the first set of features based on the set of search queries in the second language.

For example, a CTR feature may be in the format of <term, product_id>->ctr. Two example CTR features in an English service may be:
<apple, 1>->0.1
<apple, 2>->0.09.

The above CTR features suggest that if a user searches for “apple,” there is a 10% chance they will click on a product associated with product ID “1” when it is displayed. Conversely, there is a 9% chance of the user clicking on a product connected to product ID “2” when presented.

“Apple” as a search query may be translated to “pomme” in French. Two corresponding CTR features in a French service (assuming products 1 and 2 are also available in the French service) generated based on translated queries may be:
<pomme, 1>->0.1
<pomme, 2>->0.09

The translated search queries and the second set of features can then be used to train a new model. The new model may be deployed on a new service in the second language, enabling warm start searching. In some embodiments, the translated queries in the second language generated as described herein and the corresponding features that were obtained from the original query in the first language can be used to warm-start or query-related models, such as search ranking models, search embedding models, and the like. As more data gets collected in the second language, these models can be further trained.

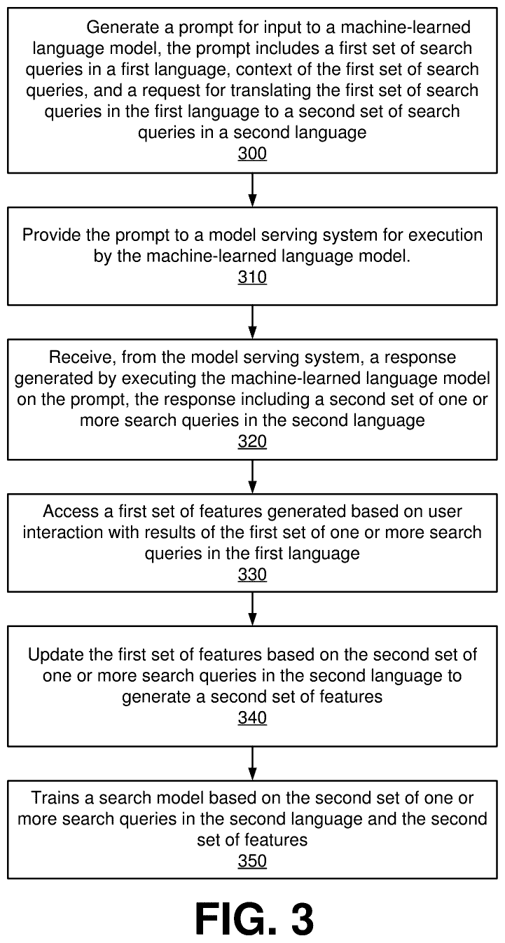

FIG. 3 is a flowchart for a method of training a search model in a second language using a large language model (LLM). Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 generates 300 a prompt for input to a machine-learned language model. The prompt includes a first set of search queries in a first language, context of the first set of search queries, and a request for translating the first set of search queries in the first language to a second set of search queries in a second language. The context may include retailer and/or user information. The context may be obtained from search logs along with the query. The retailer context can capture differences in brands versus categories. For example, the query of “ABC” may be referred to a fruit in a grocery retailer context, but the same query may be referred to an electronics device in a consumer electronics retailer context. In some embodiments, the context may also include metadata about top converting products, such as name, category, dietary attributes of the top converting products, etc.

In some embodiments, the prompt may include text. Alternatively, or in addition, the prompt may also include image, sound, video, or other modalities of data.

In some embodiments, the set of search queries is preprocessed to correct spelling errors before placing them into the prompt. In some embodiments, the set of queries in the first language or the request may be reformatted into standard formats, e.g., {query: ABC, retailer_type: grocery, language: spanish}, {query: ABC, retailer_type: electronics, language: spanish}. In some embodiments, the set of queries in the first language may include a single query. Alternatively, the set of queries in the first language may include a batch of queries.

The online system 140 provides 310 the prompt to a model serving system for execution by the machine-learned language model. The online system 140 receives 320, from the model serving system, a response generated by executing the machine-learned language model on the prompt. The response includes a second set of one or more search queries in the second language.

In some embodiments, the request for translating the first set of search queries further includes a request for translating each search query in the first language into multiple search queries in the second language. For example, the query item “orange” associated with a grocery retailer type may be translated into “naranja,” “naranjas,” “naranja roja,” “naranja verde,” “naranja fresca,” “naranja Valencia,” “naranja sanguina,” and “naranja orgánica” in Spanish; query item “orange” corresponding to retailer type of electronics may be translated into “teléfono”, “cellular”. “phone”, “computadora”, and “Teléfono móvil” in Spanish. As such, the second set of one or more search queries may include a greater number of search queries than that of the first set of search queries. In some embodiments, the online system 140 may reuse the best-performing translations to further optimize the prompt and cause the LLM to generate better translations.

The online system 140 accesses 330 a first set of features generated based on user interactions with results of the first set of one or more search queries in the first language. In some embodiments, a feature includes a click-through rate (CTR) associated with a search term in the first language and a product ID. A CTR represents a rate at which users click on a product linked to that product ID when they input the corresponding search term. For example, a CTR feature may be a CTR 0.1 associated with a search term “apple” and a product ID “1.” This CTR feature indicates that when a user searches “apple”, the system presents a product linked to product ID “1”, the user has 10% likelihood to click the product link. In some embodiments, a CTR feature may be text in a particular format, e.g., <term, product_id>->ctr. Based on this CTR format, if a search term “apple” with a product ID 1 as a search result corresponds to a click-through rate 0.1, the CTR feature is represented as <apple, 1>->0.1.

The online system 140 updates 340 the first set of features based on the second set of one or more search queries in the second language to generate a second set of features. For example, search term “apple” in English may be translated into “pomme” in French. Accordingly, the CTR feature <apple, 1>->0.1 may be converted to <pomme, 1>->0.1.

The online system 140 can then train 350 a search model based on the second set of one or more search queries in the second language and the second set of features. The newly trained search model can then be deployed onto a new service in the second language to enable cold start search.

When the new service receives a search query from a user, the new service uses the trained search model to identify features associated with the search query. For example, when a user searches “pomme” in French, the search model determines a CTR feature associated with “pomme.” The CTR feature may include <pomme, 1>->0.1, which represents that if a user searches “pomme”, a product with ID 1 is presented to the user, a click-through rate 0.1. There may be multiple CTR features associated with “pomme.” The search model may rank the different CTR features, select the products with IDs corresponding to highest CTRs, and present the selected products to the user. In some embodiments, the search model may present the selected products in an order of their CTRs, with the product having the highest CTR at top.

Cold-starting search models for different languages is difficult especially in a grocery e-commerce setting due to the short queries and very localized terms for products that cannot be immediately obtained from regular text models. LLMs with their world knowledge can be very helpful here as they can generate translations for existing queries on the online platform that are localized to an international region and also generate synthetic queries as a cold-start dataset to train search models.

In some embodiments, the LLMs can be used in different aspects to generate synthetic training data for training search-related machine-learning models. First, LLMs can generate synthetic queries based on products in a catalog, e.g., ABC ultrabook->ABC laptop, ABC charger, laptop, phone charger etc. This is helpful for generating cold-start training data based on existing products in the product catalog. Further, LLMs can generate translations and synthetic queries based on existing queries in the search logs along with the request context such as retailer, user past searches etc., such as ABC->phone, ultrabook, phone charger, etc. The generated synthetic data can be used to train downstream search models such as a query understanding model, a CTR model, a recall model, and a ranking model. The query understanding model is trained to interpret search queries to determine semantic meanings of the search queries. The CTR model is trained to determine to a probability a user will click a product when the product is displayed to the user. The recall model is trained to retrieve products for a given query. The ranking model is trained to rank the retrieved products.

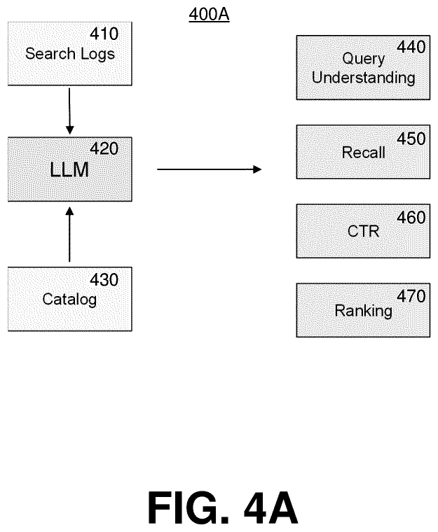

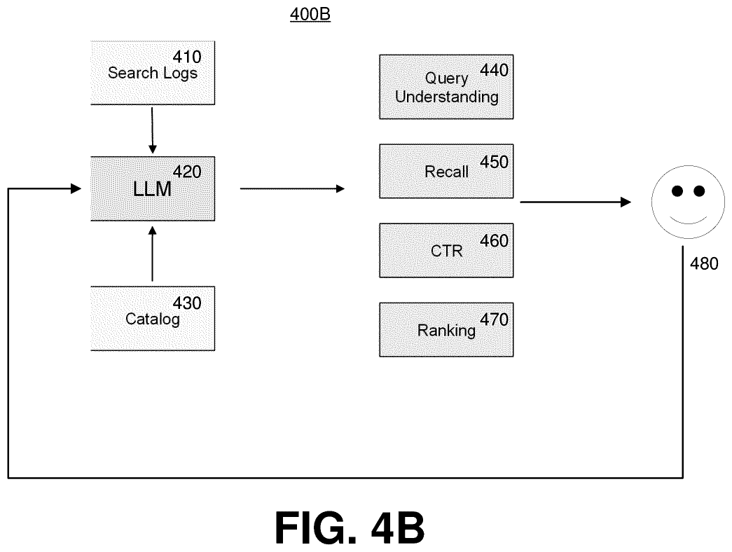

FIG. 4A illustrates an example process 400A of generating synthetic data for training various search models, in accordance with one or more embodiments. As illustrated, search logs 410 and catalog 430 are input to LLM 420. A search log is a record of past user search activity on an online platform. It may include information about the queries users have entered into a search engine, as well as additional data that provides context for each query, such as search query, time of search, user context, click-through data, search results, and interaction data. The search query may be the exact terms or phrases that the user typed in. Time of search is when the search was conducted. User context includes information such as the user's location, device, or browsing history. The search results are the results shown for that query and how they were ranked. Click-through data includes whether or not the user clicked on a search result, and if so, which one. The interaction data includes information on user actions after the search, such as whether the user made a purchase, viewed a product, or abandoned the search.

The catalog includes a database of products that are available for purchase through the online platform. This catalog may include detailed information about various items offered by different retailers that partner with the online system, such as product names, product categories, pricing information, stock availability, product descriptions, and retailer-specific information. For example, “ABC” may represent a brand of electronic devices, but “ABC” could also refer to a type of fruit. Product names might include specific identifiers, such as “ABC laptop” or “ABC fruit,” while product categories could span across fruits, electronics, groceries, household goods, and more.

The LLM 420 processes the received information, including search logs 410 and catalog 430, and generates synthetic queries, which include alternative ways to describe products, e.g., “ABC ultrabook” to “ABC laptop,” “ABC charger”, as well as translations of existing queries for new languages. The generated synthetic data is then used to train various models, such as query understanding model 440, recall model 450, CTR model 460, and a ranking model 470.

The query understanding model 440 is trained to interpret and understand the user's intent behind a search query. For example, “ABC” may be a brand for electronic devices, and it may mean something else, such as a fruit. When a user types a query like “ABC,” the query understanding model determines whether the user is searching for the fruit ABC or an ABC device (like an ABC phone or ABC laptop) based on the context of the query, user history, and product categories. In some embodiments, the query understanding model 440 applies natural language processing (NLP) techniques to extract meaning and context from user input. If a user has recently searched for electronic devices, the model might infer that “ABC” refers to the brand rather than the fruit.

The recall model 450 is trained to retrieve relevant products from the product catalog 430 based on the user's query. In some embodiments, the recall model 450 finds a broad set of potential products that could match the search query. It scans the catalog 430 for items related to the users' input and returns a set of possible results. The goal is to ensure that the relevant products are included in the results pool. For example, if a user searched for “laptop,” the recall model 450 may return a list of laptops available in the catalog, regardless of brand or price.

The CTR model 460 is configured to predict how likely a user is to click on a specific product from the search results. The CTR model 460 determines the probability that a user will click on a product link when the product link appears in search results. The CTR model 460 may consider various factors like product popularity, past user behavior, and product positioning to estimate the likelihood of a click. For example, if a user searches for “ABC,” and based on historical data, users typically click on ABC phone more often than ABC laptop for that query, the CTR model will determine the CTR for ABC phone is higher than the CTR of ABC laptop.

The ranking model 470 is configured to sort and prioritize the retrieved products based on relevance and likelihood of conversion. After the recall model 450 returns a set of potential results and the CTR model 460 estimates the likelihood of each being clicked, the ranking model orders the results. In some embodiments, the ranking model 470 considers relevance, CTR predictions, user preferences, and other factors to display the most relevant products at the top of the search results. For example, if a user searches for “ABC laptop,” the ranking model will sort the retrieved products and place the most relevant and highly rated ABC laptops at the top of the list.

Once the platform is set up for cold start and has launched in a new region, the system could also fine-tune the LLM with engagement data from new search logs to continue augmenting the original cold-start dataset. FIG. 4B illustrates an example process 400B for continuously improving various search models in an online platform, in accordance with one or more embodiments. After the platform (which may be trained based on the cold start process described with respect to FIG. 4A) is launched, users can start use the online platform to perform searches, and new search logs 480 from users are received and collected. These new search logs 480 represent user interactions with the cold start platform. The new search logs 480 can be input to the LLM 420, which uses the new search logs 480 to generate additional synthetic data to fine-tune the various models 440, 450, 460, 470. This may be an iterative process, which continues to evolve, causing the models to deliver more accurate and relevant results over time. In some embodiments, the new search logs 480 are batch processed by the LLM 420 periodically, e.g., every day, every week, every month, to generate synthetic data to retrain the models 440, 450, 460, 470. As a result, the search models 440-470 continuously improve and adapt to current user search trends and behaviors.

### LLM Selection Based on Estimated Search Query Difficulty

Traditional machine learning models may be sufficient for handling simple queries, offering faster responses with lower computational resources. However, more complex queries require the capabilities of LLMs. LLMs can provide greater accuracy but come with higher processing costs and increased latency. Processing all queries using LLMs, regardless of complexity, wastes resources and leads to unnecessary delays. Additionally, similar queries are often submitted repeatedly, making redundant computation inefficient.

Embodiments described herein solve the above-described problems by estimating the difficulty of each search query and intelligently routing simple queries to traditional ML models and complex queries to LLMs. The system also checks for cached responses to similar queries, further optimizing system performance by reducing redundant processing and response time.

In some embodiments, an online system 140 estimates the difficulty of a search query received from a customer and determines whether the search query is simple enough to provide to a traditional machine learning model to process or complex enough that it should be provided to a large language model (LLM) to process. If the search query is similar to a cached search query, the online system provides the cached response corresponding to the cached search query as the response to the search query. If the search query is not similar to a cached search query but is relatively simple, the online system provides the search query to the traditional machine learning model and provides the output of the machine learning model as the response to the search query. If the search query is not similar to a cached search query and is relatively complex, the online system provides the search query to the LLM and provides the response from the LLM as the response to the search query.

By estimating the difficulty of a search query, the online system can intelligently split system request traffic into two parts: simple search requests that are served well by traditional machine learning models, leading to high quality results with low latency, and complex search requests that are served well by LLMs, leading to improved accuracy at a small latency cost. Additionally, determining if a search query is similar to a cached search query allows the online system to shortcut providing the search query to either a traditional machine learning model or an LLM, contributing to no LLM-specific latency increase for these search queries.

In one or more embodiments, the online system 140 performs a query difficulty estimation process for a search query received from a customer client device 100 corresponding to a customer of the online system 140. To process search queries and provide search results, the online system 140 may leverage large language models (LLMs). Use of LLMs allows the online system to leverage intelligent systems that can understand search queries better than ad-hoc systems like traditional machine learning models. However, leveraging LLMs in large scale systems is challenging, as LLM inference is both costly and time consuming. Processing every search query using LLM inference can lead to significant latency increase and high compute costs for the online system. Moreover, an increase in latency can be a significant driver of metric regression.

In one or more embodiments, the online system 140 determines whether the difficulty of the query is simple enough to provide to a traditional machine learning model to process or complex enough that it should be provided to an LLM to process. The online system 140 makes the determination by applying a low latency decision making model to the features of the search query. The low latency machine learning model takes the extracted features of the search query as input and outputs the model that the online system 140 should provide the search query to. In response to determining that the search query difficulty is complex, the online system 140 prepares a prompt for input to the model serving system 150 to process the search query using an LLM. The online system 140 receives a response to the prompt from the model serving system 150 based on execution of the large language model using the prompt. The online system 140 provides the response for display on the customer client device 100. For example, the response from the LLM can be mapped to items in a product catalog and the list of identified items can be presented to the user.

In response to determining that the search query is simple, the online system 140 prepares an input to a search system or search model (that may be a machine learning model) to process the search query using a machine learning model. The online system 140 receives a response based on execution of the search machine learning model. The online system 140 provides the response for display on the customer client device 100.

Referring back to FIG. 2, The query difficulty estimation (QDE) module 226 estimates the difficulty of a search query and determines whether the search query is simple enough to provide to a search machine learning model to process or complex enough that it should be provided to an LLM deployed by the model serving system 150 to process. In one or more embodiments, in response to determining which model to process the search query with, the QDE module 226 requests for the model serving system 150 to process the query with the determined model and provides the output of the model for display on the customer client device 100.

The QDE module 226 receives a search query from a customer client device 100. A search query is free text for a word or set of words that indicate items of interest to the customer, for example “apples, milk, eggs,” “healthy snacks,” or “lunch items for kids.” A user may submit the search query to the online system 140 to receive a set of search results corresponding to the search query, for example, a list of items relevant to the search query and that the user can add to their cart.

In one or more embodiments, the QDE module 226 may generate a search query embedding for the search query. Like how the content presentation module 210 generates search query representations, the QDE module 226 may apply NLP techniques or a machine learning model to the text in the search query to generate a search query embedding that represents characteristics of the search query. In one or more embodiments, the QDE module 226 may extract a set of features from the search query. Features may include the text of the search query, previous engagements with the search query (e.g., the number of clicks or purchases previous search query results similar or identical to the current input query have received), item recall for the search query (e.g., items previously presented as search query results), or internal catalog features associated with the query (e.g., brands, retailer names, dietary attributes related to the query).

The QDE module 226 computes similarity scores between the search query and a set of cached search queries. A cached search query is a search query that the online system 140 previously provided to the model serving system 150 to be processed by the LLM. The cached search query has a corresponding cached response from the LLM, which the online system 140 received from the model serving system 150 and cached along with the query (e.g., in data store 240). For example, for a previously provided search query “healthy snacks,” responses from the LLM may be “cheese sticks,” “whole grain crackers,” and “baby carrots.” The online system 140 may cache the search query “healthy snacks” along with the responses from the LLM.

The QDE module 226 may then access the cached search query and cached response and compute a similarity score between the cached search query and the search query received from a user of the customer client device 100. The similarity score represents how similar the search query is to a cached query. For example, for a search query “snacks which are healthy,” a cached query “healthy snacks” may have a high similarity score while a cached query “lunch items for kids” may have a lower similarity score. The QDE module 226 may compute the similarity score based on the search query embedding and an embedding for the cached search query, a “cached search query embedding.” In one or more embodiments, the QDE module 226 may generate the cached search query embedding for a cached search query or extract features from the cached search query. The QDE module 226 may compute the similarity score by computing the cosine similarity, Euclidean similarity, or dot product between the two embeddings. In one or more embodiments, the QDE module 226 may compute a similarity score for each cached search query in a set of cached search queries.

The QDE module 226 makes a first estimation of whether the search query is similar enough to a cached search query such that the QDE module 226 may provide the corresponding cached search query response as a response to the search query. This approach provides benefits as, if the search query is similar enough, the QDE module 226 can shortcut providing the search query to either a traditional search machine learning model or an LLM to return search results, saving on the time and cost associated with running models as well as contributing to no LLM-specific latency increase.

The QDE module 226 determines, for example, the cached search query with the highest similarity score. The QDE module 226 compares the highest similarity score to a threshold similarity score. In response to the highest similarity score exceeding the threshold similarity score, the QDE module 226 retrieves the cached response corresponding to the cached search query with the highest similarity score. The QDE module 226 provides the cached response for display on the customer client device 100 as a response to the search query.

If there is not a cached search query that is above the threshold similarity, the QDE module 226 makes a second estimation of the difficulty of the search query. The second estimation represents whether the search query is difficult enough that the QDE module 226 should provide the search query to the LLM to be processed or whether the QDE module 226 should provide the search query to a search machine learning model. In one instance, the search model may be configured to receive an input query and/or one or more input features of the input query and determine one or more rankings of items that are relevant to the input query as a response. Therefore, in contrast to an LLM that has millions or billions of parameters and encodes vast amounts of training data, the search machine learning model may generate a response to the input query in a different manner than a response generated by the LLM, or moreover, may have access to different types of data than an LLM.

To make the second estimation, the QDE module 226 applies a low latency decision making model to the features of the search query. In one instance, the decision-making model is configured as a machine learning model, for example, a neural network. The low latency machine learning model takes the extracted features of the search query as input and outputs the model (e.g., search model or LLM) that the QDE module 226 should provide the search query to.

In one or more embodiments, before the decision-making model is executed, the QDE module 226 maintains a human-editable or machine-editable list of rules that first dictate whether a search query should be provided to the LLM of the model serving system 150 or the search model. For example, the set or rules may indicate that if a search query contains a well-known branded item, the search query is routed to the existing search model rather than the LLM. Another example is the most popular queries or search terms for each item in the product catalog. Because these queries are known to result in higher conversion or interaction rates by users, these queries are also automatically routed to the search machine learning model.

In one or more embodiments, the low latency machine learning model is trained (e.g., by the machine learning training module 230) based on a set of training data. The training data includes search queries labelled by whether they are complex/difficult and should be provided to the LLM (e.g., label of numerical value 1) or simple and should be provided to the traditional machine learning model (e.g., label of numerical value −1). For example, search queries like “apples,” “oat milk,” or “cage-free eggs” may be labelled as simple keyword-based search queries while search queries like “healthy snacks,” “snacks without nuts for kids,” and “what are some healthy alternatives to eggs?” may be labelled as complex search queries that are more suitable for processing by the LLM.

The training data may be human-labeled, automatically labelled based on a characteristic (e.g., the time it took to process the search query with an LLM), or labeled using a different LLM. In one or more embodiments, the training data may be generated by an LLM prompted to generate complex search queries suitable for an LLM and simple search queries suitable for a search machine learning model.

In one or more embodiments, as described above, the QDE module 226 makes the second estimation by applying a set of rules (human or machine-editable) to the features of the search query. One example rule may be to provide the search query to the LLM if the features include an aisle or department (e.g., “bakery desserts” or “pharmacy”). Another example rule may be to provide the search query to the traditional machine learning model if the features include a query for a popular product. Another example rule may be to provide the search query to the traditional machine learning model if the features include the name of a brand. The search queries in the training data that fall into these rules are labeled with the appropriate label depending on whether they should be routed to the LLM or the existing search model.

In response to a determination to provide the search query to the LLM, the QDE module 226 provides the search query to the LLM. The QDE module 226 generates a prompt for input to the LLM based on the search query. For example, the QDE module 226 may generate a prompt like “Provide ten grocery store items in response to the question ‘what are good alternatives to eggs?’” In one or more embodiments, the QDE module 226 may provide the LLM with additional information, such as the features of the search query, user data, order data, or item data. The QDE module 226 receives a response from the LLM and may process the response. For example, the QDE module 226 may match items provided by the LLM to available items at a particular retailer. The QDE module 226 provides the response for display on the customer client device 100 as a response to the search query.

In response to determining to provide the search query to the traditional machine learning model, the QDE module 226 provides the search query to the traditional machine learning model. For example, the traditional machine learning model is a machine learning model that is trained to score items for a customer based on the search query. The traditional machine learning model may be a combination of the item selection model and natural language processing techniques described with respect to the content presentation module 210. The QDE module 226 receives a response from the traditional machine learning model and provides the response for display on the customer client device 100 as a response to the search query.

Since certain queries need to be processed real-time, such as search queries by users, search queries can be sensitive to latency. However, often times an existing search model may be insufficient to process complex and difficult queries, and LLM's may be suitable to provide more accurate responses to such queries with some cost of latency. Therefore, by deploying the decision-making component that routes an input query to an appropriate model, the proposed system can achieve high-accuracy for difficult queries, lower latency for queries that can be quickly looked up by an existing search model or in the cache, and low cost.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine learning training module 230 may further train parameters of the machine-learned model based on data specific to the online system 140 stored in the data store 240. As an example, the machine learning training module 230 may obtain a pre-trained transformer language model and further fine tune the parameters of the transformer model using training data stored in the data store 240. The machine learning training module 230 may provide the model to the model serving system 150 for deployment.

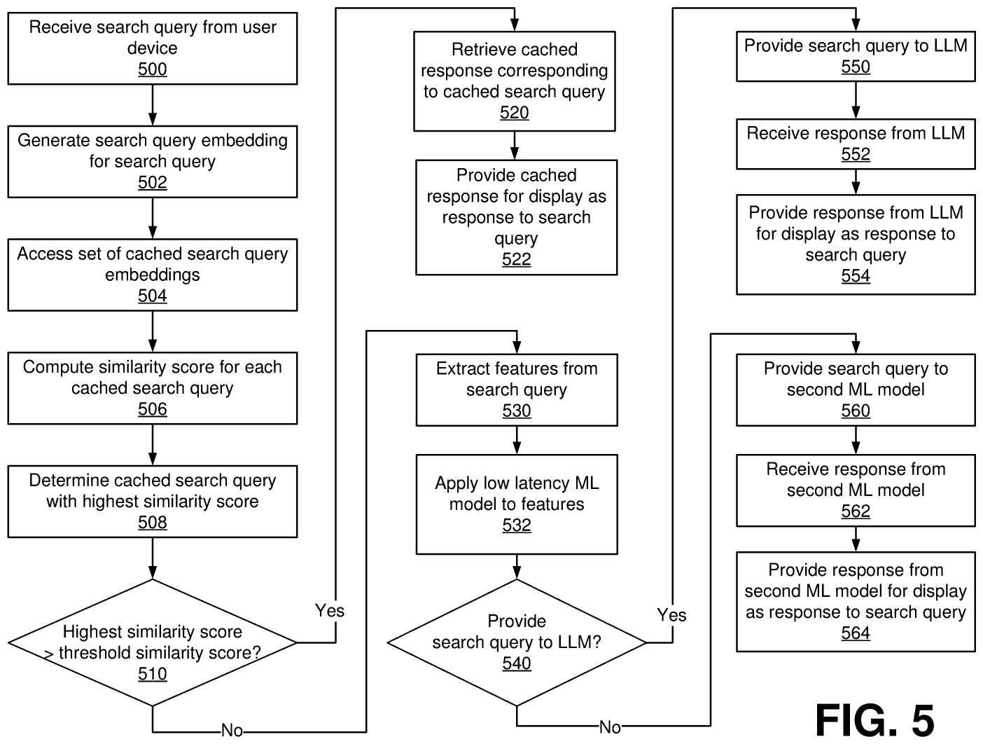

FIG. 5 is a flowchart for a method of query difficulty estimation process in accordance with one or more embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The process begins with the online system 140 receiving 500 a search query from a user device (e.g., a customer client device 100). A user may submit the search query to the online system to receive a set of search results corresponding to the search query.

The online system 140 generates 502 a search query embedding for the search query that represents the characteristics of the search query. The online system 140 may generate the search query embedding by applying NLP techniques or a machine learning model to the text of the search query.

The online system 140 accesses 504 a set of cached search query embeddings, for example from the data store 240. In one or more embodiments, online system 140 may generate the cached search query embeddings from a set of cached search queries.

The online system 140 computes 506 a similarity score for each cached search query. The online system 140 may compute the similarity score by computing the cosine similarity, Euclidean similarity, or dot product between a cached search query embedding corresponding to the cached search query and the search query embedding corresponding to the received search query.

The online system 140 determines 508 the cached search query with the highest similarity score and compares 510 the highest similarity score to a threshold similarity score.

In response to the highest similarity score exceeding the threshold similarity score, the online system 140 retrieves 520 the cached response corresponding to the cached search query with the highest similarity score. The online system provides 522 the cached response for display on the customer client device 100 as a response to the search query.

In response to the highest similarity score not exceeding the similarity score threshold, the online system 140 extracts 530 features from the search query and applies 532 a low latency machine learning model to the features. The low latency machine learning model takes the features of the search query as input and determines 540 whether the online system 140 should provide the search query to the LLM or to a second machine learning model (e.g., a traditional machine learning model).

In response to determining to provide the search query to the LLM, the online system 140 provides 550 the search query to the LLM. The online system 140 generates a prompt for input to the LLM based on the search query and may provide the LLM with additional information, such as the features of the search query, user data, order data, or item data. The online system receives 552 a response from the LLM and provides 554 the response for display on the customer client device 100 as a response to the search query.

In response to determining not to provide the search query to the LLM and instead provide the search query to the second ML model, the online system 140 provides 560 the search query to the second ML model. The online system receives 562 a response from the second ML model and provides 564 the response for display on the customer client device 100 as a response to the search query.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
obtaining a first search log for a first set of search queries in a first language and context of the first set of search queries;
generating one or more prompts for input to a machine-learned language model, the one or more prompts including the first set of search queries in the first language, the context of the first set of search queries, and a request for translating the first set more search queries in the first language to a second language different from the first language;
providing the one or more prompts for execution by the machine-learned language model;
receiving a response generated by executing the machine-learned language model on the prompt, the response including a second set of search queries in the second language;
accessing a first set of features generated based on user interactions with results of the first set of search queries in the first language;
generating a second set of features for the second set of search queries based on the first set of features; and
training a machine-learning search model based on the second set of search queries and the second set of features.

2. The method of claim 1, wherein accessing the first set of features comprises, for a search query in the first set, accessing one or more product identifiers (IDs) for products retrieved for the search query and interaction rates associated with each product ID.

3. The method of claim 1, wherein obtaining the context for a search query in the first set includes one or a combination of: a type of retailer store the search query was submitted for, user profile information of a user who submitted the search query.

4. The method of claim 1, wherein the machine-learned language model generates a plurality of translations for each search query in the first set of one or more search queries based on the context.

5. The method of claim 1, further comprising:
collecting the first search log for the first set of one or more search queries in the first language and context of the first set of one or more search queries from a first online platform in the first language, and
deploying the machine-learning search model in the second language onto a second online platform in a second language.

6. The method of claim 5, further comprising:
collecting a third search log for a third set of one or more search queries in the second language and context of the third set of one or more search queries from the second online platform in the first language; and
fine-tuning the search model based on the third search log and corresponding context.

7. The method of claim 5, further comprising:
periodically fine-tuning the search model based on a new search log and corresponding context generated by recent user interactions with the second online platform in the second language.

8. The method of claim 1, wherein the search model includes a query understanding model configured to interpret a search query to determine context of the search query, the context indicating a category of products the search query is intended to search.

9. The method of claim 1, wherein the search model includes a recall model configured to retrieve a set of products from a catalog database based on a search query.

10. The method of claim 1, wherein the search model includes a click through rate model configured to determine a probability that a user will click on a particular product when the particular product is shown in a search result.

11. The method of claim 10, wherein the search model includes a ranking model configured to rank search results based on one or more criteria, the one or more criteria including click through rates of products in the search result.

12. The method of claim 1, the method further comprising:
applying the trained machine-learning search model to process new search queries in the second language, wherein applying the model produces search results based on the second set of features;
collecting user feedback on the search results provided by the model, wherein the feedback comprises one or more interaction rates associated with the search results; and
refining the trained machine-learning search model based on the user feedback to adjust model parameters and improve subsequent search result accuracy and relevance.

13. A non-transitory computer-readable medium, having instructions encoded thereon that, when executed by one or more processors, cause the one or more processors to perform steps comprising:
obtaining a first search log for a first set of search queries in a first language and context of the first set of search queries;
generating one or more prompts for input to a machine-learned language model, the one or more prompts including the first set of search queries in the first language, the context of the first set of search queries, and a request for translating the first set more search queries in the first language to a second language different from the first language;
providing the one or more prompts for execution by the machine-learned language model;
receiving a response generated by executing the machine-learned language model on the prompt, the response including a second set of search queries in the second language;
accessing a first set of features generated based on user interactions with results of the first set of search queries in the first language;
generating a second set of features for the second set of search queries based on the first set of features; and
training a machine-learning search model based on the second set of search queries and the second set of features.

14. The non-transitory computer-readable medium of claim 13, wherein accessing the first set of features comprises, for a search query in the first set, accessing one or more product identifiers (IDs) for products retrieved for the search query and interaction rates associated with each product ID.

15. The non-transitory computer-readable medium of claim 13, wherein obtaining the context for a search query in the first set includes one or a combination of: a type of retailer store the search query was submitted for, user profile information of a user who submitted the search query.

16. The non-transitory computer-readable medium of claim 13, wherein the machine-learned language model generates a plurality of translations for each search query in the first set of one or more search queries based on the context.

17. The non-transitory computer-readable medium of claim 13, the steps further comprising:
collecting the first search log for the first set of one or more search queries in the first language and context of the first set of one or more search queries from a first online platform in the first language, and
deploying the machine-learning search model in the second language onto a second online platform in a second language.

18. The non-transitory computer-readable medium of claim 17, the steps further comprising:
collecting a third search log for a third set of one or more search queries in the second language and context of the third set of one or more search queries from the second online platform in the first language; and
fine-tuning the search model based the third search log and corresponding context.

19. The non-transitory computer-readable medium of claim 17, the steps further comprising:
applying the trained machine-learning search model to process new search queries in the second language, wherein applying the model produces search results based on the second set of features;
collecting user feedback on the search results provided by the model, wherein the feedback comprises one or more interaction rates associated with the search results; and
refining the trained machine-learning search model based on the user feedback to adjust model parameters and improve subsequent search result accuracy and relevance.

20. A computing system, comprising:
one or more processors;
non-transitory computer-readable medium, having instructions encoded thereon that, when executed by the one or more processors, cause the one or more processors to perform steps comprising:
obtaining a first search log for a first set of search queries in a first language and context of the first set of search queries;
generating one or more prompts for input to a machine-learned language model, the one or more prompts including the first set of search queries in the first language, the context of the first set of search queries, and a request for translating the first set more search queries in the first language to a second language different from the first language;
providing the one or more prompts for execution by the machine-learned language model;
receiving a response generated by executing the machine-learned language model on the prompt, the response including a second set of search queries in the second language;
accessing a first set of features generated based on user interactions with results of the first set of search queries in the first language;
generating a second set of features for the second set of search queries based on the first set of features; and
training a machine-learning search model based on the second set of search queries and the second set of features.
